(19) United States
(12) Patent Application Publication
(10) Pub. No.: US 2012/0115513 A1
(43) Pub. Date: May 10, 2012

(54) METHOD FOR DISPLAYING AUGMENTED REALITY INFORMATION AND MOBILE TERMINAL USING THE METHOD

(75) Inventor: Sangyoun HAN, Seongnam (KR)

(73) Assignee: LG Electronics Inc.

(21) Appl. No.: 13/156,044

(22) Filed: Jun. 8, 2011

(30) Foreign Application Priority Data
Nov. 9, 2010 (KR) 10-2010-0111175

(51) Int. Cl. H04W 24/00; H04W 88/02

(52) U.S. Cl. 455/456.3; 455/73

(57) ABSTRACT

A method for displaying information and a mobile terminal using the same are disclosed. A method for displaying AR information of a mobile terminal, including: capturing an image of a subject; transmitting information designating the captured image of the subject to a server; receiving augmented reality (AR) information relevant to the captured image of the subject; and displaying the received AR information based on filtering information stored in the mobile terminal.

### CROSS-REFERENCE TO RELATED APPLICATION(S)

Pursuant to 35 U.S.C. §119(a), this application claims the benefit of earlier filing date and right of priority to Korean Application No. 10-2010-0111175, filed on Nov. 9, 2010, the contents of which is incorporated by reference herein in its entirety.

### BACKGROUND

1. Field

The present invention relates to a terminal and, more particularly, to an information display method and a mobile terminal using the same.

2. Background

In general, terminals may be divided into a mobile terminal and stationary terminal according to whether or not terminals are movable. In addition, mobile terminals may be divided into a handheld terminal and a vehicle mount terminal according to whether or not users can directly carry it around.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device. Efforts are ongoing to support and increase the functionality of mobile terminals. Such efforts include software and hardware improvements, as well as changes and improvements in the structural components which form the mobile terminal.

The related art terminal provides various types of information regarding reality objects to a user by using an augmented reality (AR) technique. The augmented reality technique is applied such that when a mobile terminal provides GPS information and/or geomagnetic information to a server, the server determines the location and/or direction of the mobile terminal and provides guide information (i.e., augmented reality information) regarding a subject whose image is being captured by a camera of the mobile terminal.

However, currently, the augmented reality information is unconditionally provided and displayed without considering whether or not the corresponding AR information is appropriate for the user (or a subscriber) of the terminal when the user permits or overlooks it.

### SUMMARY OF THE INVENTION

Therefore, in order to address the above matters, the various features described herein have been conceived.

Another object of the present invention is to provide a method for displaying augmented reality information capable of providing filtered augmented reality (AR) information to a user according to a setting of a terminal user (or subscriber) or a terminal manager (guardian).

To achieve these and other advantages and in accordance with the purpose of the present invention, as embodied and broadly described herein, the present invention provides in one aspect a method for displaying AR information of a mobile terminal, including: capturing an image of a subject; transmitting information designating the captured image of the subject to a server; receiving augmented reality (AR) information relevant to the captured image of the subject; and displaying the received AR information based on filtering information stored in the mobile terminal.

To achieve these and other advantages and in accordance with the purpose of the present invention, as embodied and broadly described herein, the present invention provides in another aspect a method for displaying AR information of a mobile terminal, including: capturing an image of a subject; transmitting information designating the captured image of the subject to a server; receiving augmented reality (AR) information relevant to the captured image of the subject from the server based on filtering information stored in the mobile terminal; and displaying the received AR information.

To achieve these and other advantages and in accordance with the purpose of the present invention, as embodied and broadly described herein, the present invention provides in another aspect a mobile terminal including: a display unit; a camera configured to capture an image of a subject; a wireless communication unit configured to transmit information for designating the captured image of the subject to a server, and receive augmented reality (AR) information relevant to the captured image of the subject from the server; and a controller configured to control the display unit to display the received AR information based on filtering information stored in a memory.

To achieve these and other advantages and in accordance with the purpose of the present invention, as embodied and broadly described herein, the present invention provides in another aspect a mobile terminal including: a display unit; a camera configured to capture an image of a subject; a wireless communication unit configured to transmit information for designating the captured image of the subject to a server, and receive augmented reality (AR) information relevant to the captured image of the subject from the server based on filtering information stored in the mobile terminal; and a controller configured to control the display unit to display the received AR information.

According to exemplary embodiments of the present invention, in the method for displaying AR information and a mobile terminal using the same, because AR information to be displayed or received is filtered according to a setting (i.e., filtering information) stored in the mobile terminal, only AR information appropriate for the age of a user (or subscriber) of the mobile terminal can be provided and unwholesome or unhealthy AR information can be blocked.

Also, because the user (or the subscriber) of the terminal or a manager (or a guardian) at the position to protect the user of the mobile terminal can filter (permit or block) AR information (or AR data) to be displayed or received by the mobile terminal in various manners and can be provided with information regarding the filtering results. Thus, AR information desired by the terminal user or only AR information suitable for the terminal user can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The embodiments will be described in detail with reference to the following drawings in which like reference numerals refer to like elements wherein:

FIG. 1 is a schematic block diagram of a mobile terminal according to an exemplary embodiment of the present invention;

FIG. 2 illustrates an example of interrupting displaying of augmented reality information by a mobile terminal according to an exemplary embodiment of the present invention;

FIGS. 3 to 5 are flow charts illustrating the processes of a method for displaying AR information according to an exemplary embodiment of the present invention; and

FIGS. 6 to 8 are flow charts illustrating the processes of a method for displaying AR information according to another exemplary embodiment of the present invention.

### DETAILED DESCRIPTION

Embodiments of the present invention will be described below in detail with reference to the accompanying drawings, where those components are rendered the same reference number that are the same or are in correspondence, regardless of the figure number, and redundant explanations are omitted. In describing the present invention, if a detailed explanation for a related known function or construction is considered to unnecessarily divert the gist of the present invention, such explanation has been omitted but would be understood by those skilled in the art. In the following description, usage of suffixes such as ‘module’, ‘part’ or ‘unit’ used for referring to elements is given merely to facilitate explanation of the present invention, without having any significant meaning by itself. In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings.

Overall Configuration of Mobile Terminal

The mobile terminal described in the present invention may include mobile phones, smart phones, notebook computers, digital broadcast receivers, PDAs (Personal Digital Assistants), PMPs (Portable Multimedia Player), navigation devices, and the like. It would be understood by a person in the art that the configuration according to the embodiments of the present invention can be also applicable to the fixed types of terminals such as digital TVs, desk top computers, or the like, except for any elements especially configured for a mobile purpose.

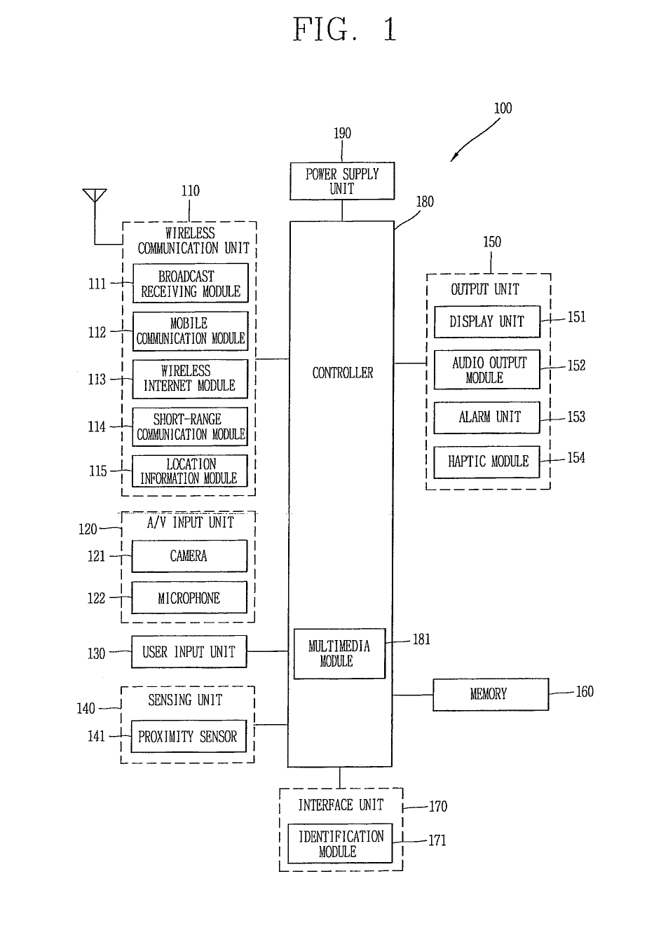

FIG. 1 is a block diagram of a mobile terminal according to an embodiment of the present invention.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, and the like. FIG. 1 shows the mobile terminal as having various components, but it should be understood that implementing all of the illustrated components is not a requirement. Greater or fewer components may alternatively be implemented.

The elements of the mobile terminal will be described in detail as follows.

The wireless communication unit 110 typically includes one or more components allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel. The broadcast associated information may refer to information associated with a broadcast channel, a broadcast program or a broadcast service provider. The broadcast associated information may also be provided via a mobile communication network and, in this case, the broadcast associated information may be received by the mobile communication module 112. Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, and the like), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), Zig Bee™, and the like.

The location information module 115 is a module for checking or acquiring a location (or position) of the mobile terminal. A typical example of the location information module is a GPS (Global Positioning System).

With reference to FIG. 1, the A/V input unit 120 is configured to receive an audio or image signal. The A/V input unit 120 may include a camera 121 (or other image capture device) and a microphone 122 (or other sound pick-up device). The camera 121 processes image data of still pictures or video obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate input data from commands entered by a user to control various operations of the mobile terminal. The user input unit 130 may include a keypad, a dome switch, a touch pad (e.g., a touch sensitive member that detects changes in resistance, pressure, capacitance, and the like, due to being contacted) a jog wheel, a jog switch, and the like.

The sensing unit 140 (or other detection means) detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, and the like, and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor 141.

The output unit 150 is configured to provide outputs in a visual, audible, and/or tactile manner (e.g., audio signal, image signal, alarm signal, vibration signal, etc.). The output unit 150 may include the display unit 151, an audio output module 152, an alarm unit 153, a haptic module 154, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, and the like.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, an e-ink display, or the like.

Some of them may be configured to be transparent or light-transmissive to allow viewing of the exterior, which may be called transparent displays. A typical transparent display may be, for example, a TOLED (Transparent Organic Light Emitting Diode) display, or the like. Through such configuration, the user can view an object positioned at the rear side of the terminal body through the region occupied by the display unit 151 of the terminal body.

The mobile terminal 100 may include two or more display units (or other display means) according to its particular desired embodiment. For example, a plurality of display units may be separately or integrally disposed on one surface of the mobile terminal, or may be separately disposed on mutually different surfaces.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

With reference to FIG. 1, a proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal reception sound, a message reception sound, etc.). The audio output module 152 may include a speaker, a buzzer, or other sound generating device.

The alarm unit 153 (or other type of user notification means) may provide outputs to inform about the occurrence of an event of the mobile terminal 100. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations (or other tactile or sensible outputs). When a call, a message, or some other incoming communication is received, the alarm unit 153 may provide tactile outputs (i.e., vibrations) to inform the user thereof. By providing such tactile outputs, the user can recognize the occurrence of various events even if his mobile phone is in the user's pocket. Outputs informing about the occurrence of an event may be also provided via the display unit 151 or the audio output module 152. The display unit 151 and the audio output module 152 may be classified as a part of the alarm unit 153.

The haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, and the like, an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM), a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

Method for Processing User Input with Respect to Mobile Terminal

The user input units 130 is manipulated to receive a command for controlling the operation of the mobile terminal 100 and may include a plurality of manipulation units 131 and 132. The manipulation units 131 and 132 may be generally referred to as a manipulating portion, and various methods and techniques can be employed for the manipulation portion so long as they can be operated by the user in a tactile manner.

The user input unit 130 is manipulated to receive a command for controlling the operation of the mobile terminal 100. The user input unit 130 may include a plurality of manipulation units. The manipulation units may be generally called a manipulating portion, and they can employ any method so long as they can be manipulated in a tactile manner by the user.

The display unit 151 can display various types of visual information. These types of information may be displayed in the form of characters, numerals, symbols, graphic or icons.

In order to input such information, at least one of the characters, numerals, symbols, graphic and icons may be displayed in predetermined arrangement in the form of a keypad. Also, the keypad can be referred to as a ‘soft key’.

The display unit 151 may be operated as an entire area or may be divided into a plurality of regions so as to be operated. In the latter case, the plurality of regions may be configured to be operated in association with each other.

For example, an output window and an input window may be displayed at an upper portion and a lower portion of the display unit 151. The output window and the input window are regions allocated to output or input information, respectively. Soft keys marked by numbers for inputting a phone number or the like may be outputted to the input window. When a soft key is touched, a number or the like corresponding to the touched soft key may be displayed on the output window. When the manipulation unit is manipulated, a call connection to the phone number displayed on the output window may be attempted or text displayed on the output window may be inputted to an application.

The display unit 151 or a touch pad may be configured to receive a touch through scrolling. The user can move an entity displayed on the display unit 151, for example, a cursor or a pointer positioned on an icon or the like, by scrolling the touch pad. In addition, when the user moves his finger on the display unit 151 or on the touch pad, a path along which the user's finger moves may be visually displayed on the display unit 151. This can be useful in editing an image displayed on the display unit 151.

A certain function of the terminal may be executed when the display unit 151 (touch screen) and the touch pad are touched together within a certain time range. For example, the display unit 151 and the touch pad may be touched together when the user clamps the terminal body by using his thumb and index fingers. The certain function may be activation or deactivation of the display unit 151 or the touch pad.

Exemplary embodiments related to a control method that can be implemented in the terminal configured as described above will now be described with reference to the accompanying drawings. The exemplary embodiments to be described may be solely used or may be combined to be used. Also, the exemplary embodiments to be described may be combined with the foregoing user interface (UI) so as to be used.

First, concepts or terms to be referred in describing exemplary embodiments in the present disclosure will now be explained.

Augmented Reality

Augmented reality (AR) refers to a direct or indirect live view in which components of a physical real world environment are augmented to appear by a virtual image generated by a computer. The AR fortifies a current recognition with respect to substance. In case of AR, augmentation is made according to a real time and semantic context with components in the real world environment, which is like the scores displayed along with a sports scene in a TV receiver. With the aid of a developed AR technique such as a computer vision and an addition of an object recognition, information regarding a real world around users is useful in an interactively digital manner. The real world environment and artificial information regarding an object in the environment may be stored and retrieved as an information layer added to a real world view.

AR Information

As described above with respect to the AR, AR information refers to guide information regarding an object existing in a real world, which can be obtained in a location-based scheme (GPS-based scheme), a marker recognition-based scheme, or the like. The objects, for which AR information can be displayed, may include every object whose guide information can be provided, such as articles, goods, buildings, a route map, public transportation, and the like. A mobile terminal may obtain AR information from a single AR information server or a plurality of AR information servers.

In detail, in the case of the location-based scheme, the mobile terminal may transmit GPS information and geomagnetic sensor information (direction, tilt information, etc.) to a server, obtain AR information regarding an object viewed by the mobile terminal (e.g., an object whose image is being captured by a camera of the mobile terminal) from the server, and display the obtained AR information on an actual image in an overlaid manner to thus provide guide information regarding the object.

Meanwhile, in the case of the marker recognition-based scheme, the mobile terminal may locate a marker appearing on an image, and recognize the size of the marker and the distance between the marker and the mobile terminal to determine a three-dimensional (3D) location of a marker-indicated object and/or distance. The mobile terminal may obtain AR information directly from the corresponding AR marker, or obtain AR information connected with the corresponding AR marker from the server and display the obtained AR information on an image or the marker position.

For example, the AR marker may be included in the form of an image, a two-dimensional (2D) code, or the like, in the Arm information, or may include various types of data such as a character, a number, a symbol, a control code, and the like. In this case, the mobile terminal may decode the image, the 2D code, or the like, of the AR marker with the AR information encoded therein to obtain the AR information. A specific scheme for configuring the AR marker with the 2D code can be understood in a similar manner to a known 2D code (e.g., QR code, PDF417, DataMatrix, MaxiCode, etc.), so a detailed description thereof will be omitted.

Alternatively, the AR marker may include information used to obtain or access AR information or provide the same. For example, the information may be a specific number given as a combination of numbers or characteristics which is different for each AR information, URL information allowing for accessing AR information, identification information (a serial number of an AR marker, or the like) identifying different AR markers, and the like. In this case, the mobile terminal may decode the image, the 2D code, or the like, of the information-encoded AR marker to obtain the information. The mobile terminal may obtain, upon inquiry to the server, AR information corresponding to said (the above-mentioned) information

AR Information Display Method and Mobile Terminal Using the Same

According to an AR information display method according to an exemplary embodiment of the present invention, AR information to be displayed or received is filtered according to a setting (filtering information) stored in the mobile terminal, whereby only AR information fitting the age of the user (subscriber) of the mobile terminal or blocking unsound or harmful AR information from being displayed.

Also, according to an AR information display method according to an exemplary embodiment of the present invention, the user (or a subscriber) himself of the mobile terminal or a manager (or a guardian) who is at a position of protecting the user of the mobile terminal can filter (permit or block) AR information (or AR data) to be displayed or received by the mobile terminal in various manners, and can receive information regarding the filtering results, whereby only AR information desired by the user of the mobile terminal or only AR information suitable for the user of the mobile terminal can be provided.

In detail, the mobile terminal 100 according to an exemplary embodiment of the present invention may filter AR information based on information (e.g., kids-lock information) regarding an age of the terminal user (subscriber) stored in a subscriber identity module (SIM), a universal subscriber identity module (USIM), and the like.

Also, the mobile terminal 100 according to an exemplary embodiment of the present invention may filter AR information based on content of a text message received from the manager (or guardian) or content directly input by the manager (or guardian) or the terminal user (or subscriber), or based on the location of the terminal.

Also, the mobile terminal 100 according to an exemplary embodiment of the present invention may activate or deactivate an AR information filtering function according to a reception message including an authentication code of the manager (or guardian). Namely, the controller 180 may be set the filtering information in order to block all the items of the AR information from being displayed or release displaying of all the items of the AR information when a message including a predetermined authentication code is received.

Also, the mobile terminal 100 according to an exemplary embodiment of the present invention may process AR information, as a blocking target, to be graphic-processed such as mosaic-processed, or stopping displaying of a preview screen image regarding scanning of a destructive area having a large number of times of blocking, display information regarding the number of times of blocking, or when the AR information has been blocked by more than a certain number of times of blocking, the mobile terminal 100 may inform the manager (guardian) accordingly.

Hereinafter, the operation or the function of the mobile terminal 100 according to a scheme of setting filtering of AR information and a scheme of displaying filtering results according to an exemplary embodiment of the present invention will now be described.

Filtering Setting Scheme

The camera 121 captures an image of a subject (or object) of a real world. The display unit 151 may display a preview screen image of the captured image.

The wireless communication unit 110 transmits information for designating the subject whose image has been captured (or the image-captured subject) to the server, and receives AR information related to the captured image of the subject from the server. Here, the server may be an AR information server. The information designating the image-captured subject may include location information and direction information of the mobile terminal which captures the image of the subject, or may include identification information of a marker indicated in or attached to the image-captured subject.

The controller 180 controls the display unit 151 to display the received AR information based on the filtering information (filtering setting) stored in the memory 160. In particular, the filtering information (filtering setting) may be stored in an SIM card or a USIM card. The filtering information may be transmitted in the form of a sort of configuration file to a remote area (e.g., a different mobile terminal) so as to e used to configure the same filtering environment in the remote area.

In this case, the filtering information (filtering setting) may include subscriber age information. The controller 180 may provide control to display the AR information only when the subscriber age is higher than a permitted age of the AR information.

To this end, age class information for designating an age to which the corresponding AR information can be provided may be added in the form of meta data to each AR information. The meta data may be stored in a certain space within a data format configuring the AR information, or may be stored in a server, or the like, separately from the AR information, and associated with the AR information.

Upon receiving the AR information from the server, the controller 180 may read the meta data included in the AR information to first check an age class of the AR information to be received. Or, before receiving the AR information, the controller 180 may receive the meta data from the server and first check the age class of the AR information to be received.

Meanwhile, the filtering information (filtering setting) may include the entirety or a portion of content of the reception information. The controller 180 may provide control to display only the AR information including information which is the same as or similar to the content of the reception message included in the filtering information. For example, the controller 180 may provide control to display only AR information including information or a phrase which is the same as or similar to at least one character, number, symbol, figure (or diagram), or a combination thereof included in the content of the reception message.

Or, the controller 180 may provide control to prevent AR information including information which is the same as or similar to the content of the reception message included in the filtering information, from being displayed. Namely, the controller 180 may provide control to prevent the AR information including information or a phrase which is the same as or similar to at least one character, number, symbol, figure (or diagram), or a combination thereof included in the content of the reception message, from being displayed.

For example, when a manager (or guardian) inputs information or a phrase desired to be blocked from being displayed to text of a message and transmitted, the mobile terminal 100, upon receiving the text message, may block AR information including the information or the phrase described in the text of the reception message from being displayed later.

Meanwhile, the filtering information (filtering setting) may include at least one character, number, symbol, figure (or diagram), or a combination thereof designated by a user input signal. The controller 180 may provide control to display only AR information including information or a phrase which is the same as or similar to the at least one designated character, or the like. Or, the controller 180 may provide control to block AR information including information or a phrase which is the same as or similar to the at least one designated character, or the like, from being displayed.

For example, when the user (or subscriber) inputs a word or a phone number desired to be blocked from being displayed, through a filtering setting screen image, the mobile terminal 100 may block AR information including the inputted word or phone number or including a similar word or phone number from being displayed.

Meanwhile, the filtering information (filtering setting) may include location information. In particular, the location information may be GPS information. The controller 180 may provide control to display AR information only when the mobile terminal 100 is adjacent to a location designated by location information included in filtering information with reference to location information provided by the location information module 115. Similarly, the controller 180 may provide control to prevent AR information from being displayed when location information included in the AR information is adjacent to a designated position.

For example, when the manager (guardian) directly inputs GPS information/address, a radius distance, or the like on a filtering setting screen image, the mobile terminal 100 may not display AR information within a determined radius from the location designated by the GPS information/address.

According to the above description, the mobile terminal 100 according to an exemplary embodiment of the present invention receives AR information, and then determines whether to display the received AR information or whether to prevent the received AR information from being blocked according to the filtering information. In this manner, the AR information can be prevented from being displayed or receiving of AR information corresponding to a target (or subject) to be blocked may be blocked. The mobile terminal 100 according to a different exemplary embodiment of the present invention may selectively receive only AR information to be displayed according to filtering information.

In detail, the wireless communication unit 110 transmits information for designating a subject whose image is to be captured to the server, and receives AR information related to the image-captured subject from the server. The controller 180 controls the display unit 15 to display the received AR information.

In particular, the wireless communication unit 110 may transmit the filtering information stored in the memory 160 to the server, and receive only permitted AR information according to the filtering information from the AR information. Namely, the server may determine whether to transmit AR information regarding the image-captured subject to the mobile terminal 100 according to the filtering information provided by the mobile terminal 100.

For example, based on subscriber age information included in the filtering information, the server may transmit the AR information to the mobile terminal 100 only when the subscriber age is higher than a permitted age according to the age class of the AR information.

The wireless communication unit 110 may transmit information for designating the image-captured subject to the server and receive a summary of the AR information regarding the image-captured subject from the server. Here, the summary of the AR information may refer to a keyword, core information, meta data, or the like, describing the AR information.

When the controller 180 determines to receive the AR information based on the filtering information and the received summary, the wireless communication unit 110 may receive the AR information or may not receive it according to the determination of the controller 180.

Or, the controller 180 may search for content of AR information received by the wireless communication unit 110 in real time, and when content or a phrase designated to be blocked is included in the filtering information, the controller 180 may control the wireless communication unit 110 to stop receiving the remaining portion of the AR information.

The mobile terminal 100 according to a different exemplary embodiment of the present invention can be understood similarly as described above with reference to the mobile terminal 100 according to an exemplary embodiment of the present invention, so a detailed description thereof will be omitted.

A method for displaying filtering results of the AR information will now be described.

Displaying of Filtering Results

As described above, the controller 180 determines whether to display AR information or whether to block AR information from being displayed based on filtering information. When the AR information is determined to be blocked from being displayed, the controller 180 may control the display unit 151 to process the AR information such that it is mosaic, blurred, or colored, so as to be displayed. Also, the controller 180 may control an object to be blocked from being displayed on a preview screen image such that it is mosaic or graphically processed so as to be displayed.

Or, as described above, when the display unit 151 displays a preview screen image of a captured image, the controller 180 may determine whether to block the AR information from being displayed on the preview screen image based on the filtering information.

When the number of items of AR information blocked from being displayed is smaller than a predetermined number, the controller f180 may control the display unit 141 to display AR information not blocked from being displayed and the preview screen image. When the number of items of AR information blocked from being displayed is equal to or greater than the predetermined number, the controller 180 may control the display unit 151 to stop displaying of the AR information and the preview screen image.

Or, when the number of items of the AR information blocked from being displayed is equal to or greater than the predetermined number, the controller 180 may control the display unit 151 to display a phrase (e.g., a phrase informing that an area is harmful to minors) indicating that the AR information is blocked from being displayed or a numerical value (e.g., a numerical value corresponding to the a harmful area index or the number of items of harmful AR information) corresponding to the number of the items of the AR information blocked from being displayed.

Meanwhile, as described above, the controller 180 may permit the AR information to be displayed or block the AR information from being displayed based on the filtering information. When the number of items of the AR information blocked from being displayed is larger than a predetermined number, the controller 180 may control the wireless communication unit 110 to transmit a notification message to a remote area (e.g., the mobile terminal of the terminal manager (or guardian).

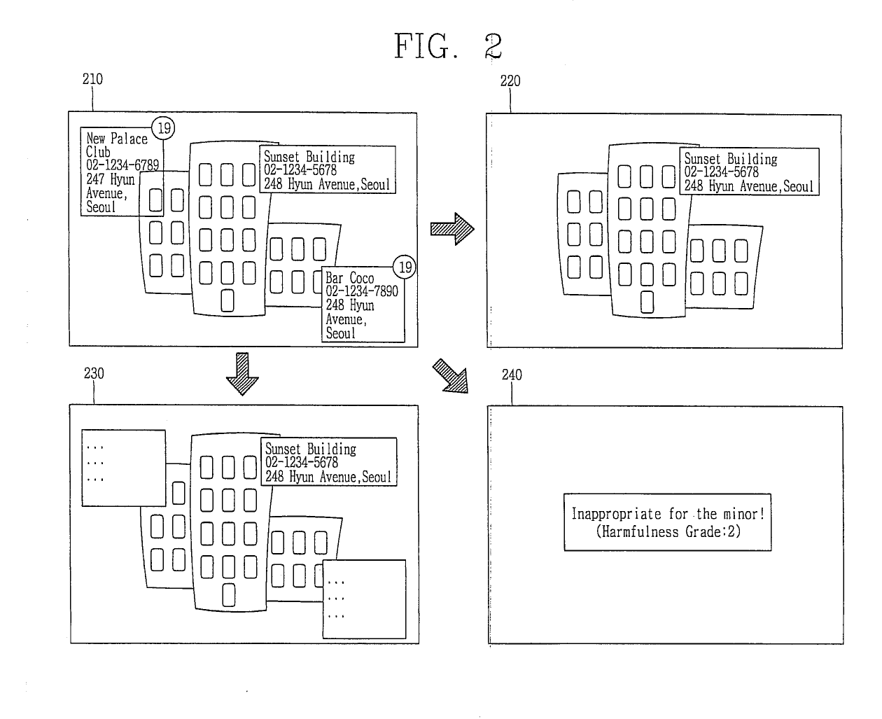

FIG. 2 illustrates an example of interrupting displaying of augmented reality information by a mobile terminal according to an exemplary embodiment of the present invention. In FIG. 2, AR information filled with dots denotes AR information which has been received but not actually displayed by the mobile terminal 100.

As shown in FIG. 2, the mobile terminal receives AR information regarding a subject whose image is to be captured (210). Hereinafter, it is assumed that AR information regarding “New Palace Club” and “Bar Coco” is information not appropriate for minors, which are targets to be blocked from being displayed.

The mobile terminal 100 may not display AR information regarding “New Palace Club” and “Bar Coco” on a preview screen image of the captured image (2200 or may process “New Palace Club” and “Bar Coco” to be mosaic so as to be displayed (230). Or, in case in which filtering setting has been set to completely block AR information and a preview screen image from being displayed when two or more targets not appropriate for minors are displayed on the preview screen image, the mobile terminal 100 may display a phrase (“Inappropriate for the minor!”) and a harmfulness grade indicating the number of targets not appropriate for minors (240), rather than displaying the preview screen image of the captured image and the AR information.

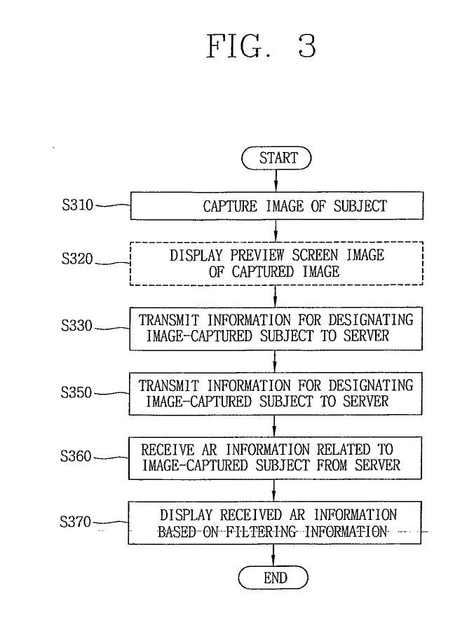

FIGS. 3 to 5 are flow charts illustrating the processes of a method for displaying AR information according to an exemplary embodiment of the present invention.

With reference to FIG. 3, the mobile terminal 100 captures an image of a subject (step S310). The mobile terminal 100 may display a preview screen image of the captured image (S320).

The mobile terminal transmits information for designating the image-captured subject to the server (step S330). Here, the information for designating the image-captured subject may include location information and direction information of the mobile terminal which captures the image of the subject or identification information of a marker indicated in or attached to the captured image of the subject.

The mobile terminal 100 receives AR information related to the captured image of the subject from the server (step S350).

The mobile terminal 100 displays the received AR information based on the filtering information stored in the mobile terminal (step S370). The filtering information may be stored in a subscriber identity module (SIM) card or in a universal subscriber identity module (USIM) card of the mobile terminal.

In this case, the filtering information may include subscriber age information, and only when a subscriber age is higher than a permitted age according to the age class of the AR information, the mobile terminal 100 may display the AR information.

Or, the filtering information may include at least a portion of content of a reception message, and the mobile terminal 100 may display the AR information including information which is the same as or similar to the content of the reception message or may prevent the received AR information including information which is the same as or similar to the content of the reception message from being displayed.

Or, the filtering information may include at least one character, number, symbol, or figure (or diagram) designated by a user input signal, and the mobile terminal 100 may display the AR information including information which is the same as or similar to the at least one character, number, symbol, or figure (or diagram), or the like, or block the AR information including information which is the same as or similar to the at least one character, number, symbol, or figure (or diagram) from being displayed.

Or, the filtering information may include location information, and the mobile terminal 100 may display the AR information only when the location information is adjacent to a location designated by the location information, or may prevent the AR information from being displayed when the location information is adjacent to the location designated by the location information.

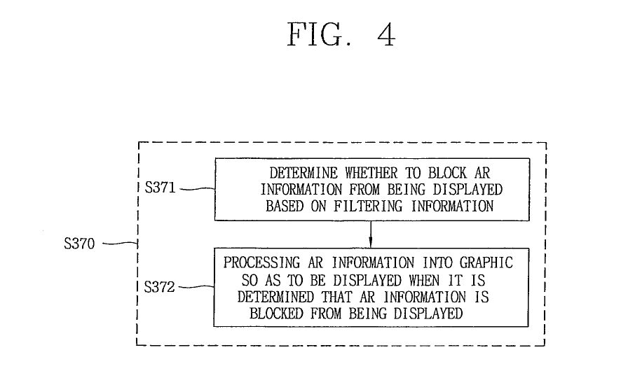

With reference to FIG. 4, the mobile terminal 100 may perform a step (S371) of determining whether to block the AR information from being displayed based on the filtering information and a step (S372) of displaying the AR information by processing it to be mosaic, blurred, or colored when it is determined to block the AR information from being displayed.

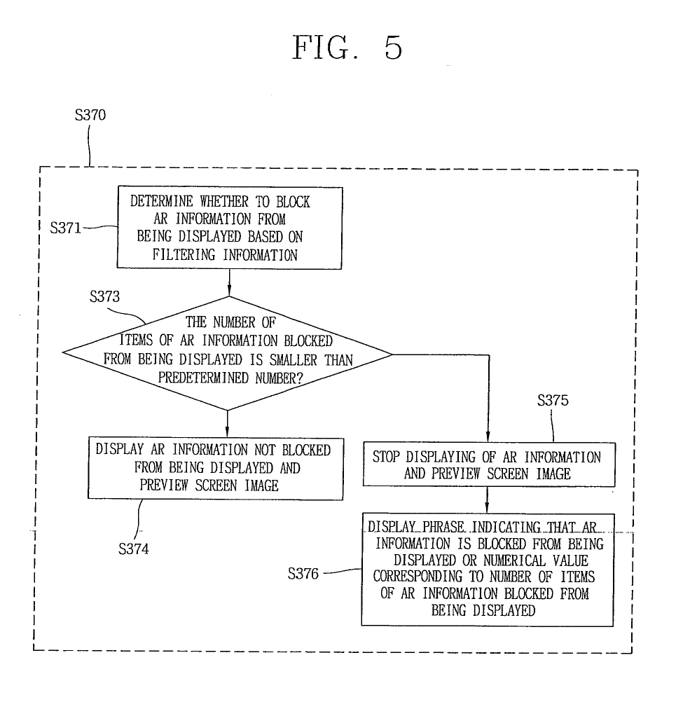

Also, with reference to FIG. 5, the mobile terminal 100 may perform a step (S371) of determining whether to block the AR information from being displayed based on the filtering information, a step (S374) of displaying AR information not blocked from being displayed and displaying the preview screen image when the number of items of the AR information blocked from being displayed is smaller than a predetermined number (step S373), and a step (S375) of stopping displaying of the AR information and the preview screen image when the number of items of the AR information blocked from being displayed is equal to or larger than a predetermined number (step S373).

In this case, when the number of items of the AR information blocked from being displayed is equal to or larger than the predetermined number, the mobile terminal 100 may perform a step (S376) of displaying a phrase indicating that displaying of the AR information is blocked or a numerical value corresponding to the number of the items of the AR information blocked from being displayed.

Meanwhile, the mobile terminal 100 may set the filtering information such that all the items of the AR information are blocked from being displayed or released from a blocked state when a message including a predetermined authentication code is received. Or, when the number of items of AR information blocked from being displayed is equal to or greater than the predetermined number, the mobile terminal 100 may transmit a notification message to a remote area. Or, the mobile terminal 100 may transmit the filtering information to the remote area.

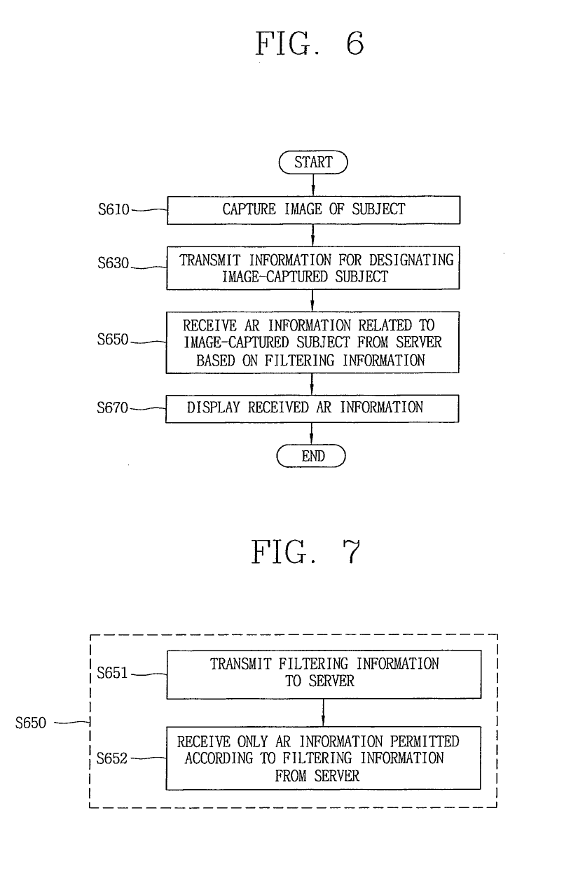

FIGS. 6 to 8 are flow charts illustrating the processes of a method for displaying AR information according to another exemplary embodiment of the present invention.

As shown in FIG. 6, the mobile terminal captures an image of a subject (step S610). The mobile terminal 100 transmits information for designating the image-captured subject to the server (S630). The mobile terminal 100 receives AR information related to the captured image of the subject from the server based on the filtering information stored in the mobile terminal (step S650). The mobile terminal displays the received AR information (step S670).

In particular, the filtering information may include subscriber age information, and only when the subscriber age is higher than a permitted age according to an age class of the AR information, the mobile terminal 100 may receive the AR information.

Or, with reference to FIG. 7, the mobile terminal 100 may perform a step (S651) of transmitting the filtering information to the server and a step (S652) of receiving only the AR information permitted according to the filtering information from the server.

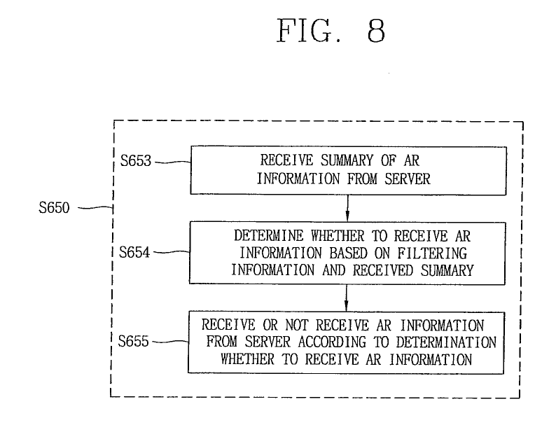

Or, with reference to FIG. 8, the mobile terminal 100 may perform a step (S653) of receiving a summary of the AR information from the server, a step (S654) of determining whether to receive the AR information based on the filtering information and the received summary, and a step (S655) of receiving or not receiving the AR information from the server according to the determination of whether to receive the AR information.

The methods according to the exemplary embodiments of the present invention can be understood similarly as described above with reference to the mobile terminal 100 according to the exemplary embodiments of the present invention with reference to FIGS. 1 and 2, so a detailed description thereof will be omitted.

In the embodiments of the present invention, the above-described method can be implemented as codes that can be read by a computer in a program-recorded medium. The computer-readable medium includes various types of recording devices in which data read by a computer system is stored. The computer-readable medium may include a ROM, a RAM, a CD-ROM, a magnetic tape, a floppy disk, an optical data storage device, and the like. The computer-readable medium also includes implementations in the form of carrier waves or signals (e.g., transmission via the Internet).

The mobile terminal according to the embodiments of the present disclosure is not limited in its application of the configurations and methods, but the entirety or a portion of the embodiments can be selectively combined to be configured into various modifications.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

Therefore, in order to address the above matters, the various features described herein have been conceived.

Another object of the present invention is to provide a method for displaying augmented reality information capable of providing filtered augmented reality (AR) information to a user according to a setting of a terminal user (or subscriber) or a terminal manager (guardian).

To achieve these and other advantages and in accordance with the purpose of the present invention, as embodied and broadly described herein, the present invention provides in one aspect a method for displaying AR information of a mobile terminal, including: capturing an image of a subject; transmitting information designating the captured image of the subject to a server; receiving augmented reality (AR) information relevant to the captured image of the subject; and displaying the received AR information based on filtering information stored in the mobile terminal.

To achieve these and other advantages and in accordance with the purpose of the present invention, as embodied and broadly described herein, the present invention provides in another aspect a method for displaying AR information of a mobile terminal, including: capturing an image of a subject; transmitting information designating the captured image of the subject to a server; receiving augmented reality (AR) information relevant to the captured image of the subject from the server based on filtering information stored in the mobile terminal; and displaying the received AR information.

To achieve these and other advantages and in accordance with the purpose of the present invention, as embodied and broadly described herein, the present invention provides in another aspect a mobile terminal including: a display unit; a camera configured to capture an image of a subject; a wireless communication unit configured to transmit information for designating the captured image of the subject to a server, and receive augmented reality (AR) information relevant to the captured image of the subject from the server; and a controller configured to control the display unit to display the received AR information based on filtering information stored in a memory.

To achieve these and other advantages and in accordance with the purpose of the present invention, as embodied and broadly described herein, the present invention provides in another aspect a mobile terminal including: a display unit; a camera configured to capture an image of a subject; a wireless communication unit configured to transmit information for designating the captured image of the subject to a server, and receive augmented reality (AR) information relevant to the captured image of the subject from the server based on filtering information stored in the mobile terminal; and a controller configured to control the display unit to display the received AR information.

According to exemplary embodiments of the present invention, in the method for displaying AR information and a mobile terminal using the same, because AR information to be displayed or received is filtered according to a setting (i.e., filtering information) stored in the mobile terminal, only AR information appropriate for the age of a user (or subscriber) of the mobile terminal can be provided and unwholesome or unhealthy AR information can be blocked.

Also, because the user (or the subscriber) of the terminal or a manager (or a guardian) at the position to protect the user of the mobile terminal can filter (permit or block) AR information (or AR data) to be displayed or received by the mobile terminal in various manners and can be provided with information regarding the filtering results. Thus, AR information desired by the terminal user or only AR information suitable for the terminal user can be provided.

The foregoing and other objects, features, aspects and advantages of the present invention will become more apparent from the following detailed description of the present invention when taken in conjunction with the accompanying drawings.

Embodiments of the present invention will be described below in detail with reference to the accompanying drawings, where those components are rendered the same reference number that are the same or are in correspondence, regardless of the figure number, and redundant explanations are omitted. In describing the present invention, if a detailed explanation for a related known function or construction is considered to unnecessarily divert the gist of the present invention, such explanation has been omitted but would be understood by those skilled in the art. In the following description, usage of suffixes such as ‘module’, ‘part’ or ‘unit’ used for referring to elements is given merely to facilitate explanation of the present invention, without having any significant meaning by itself. In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings.

Overall Configuration of Mobile Terminal

The mobile terminal described in the present invention may include mobile phones, smart phones, notebook computers, digital broadcast receivers, PDAs (Personal Digital Assistants), PMPs (Portable Multimedia Player), navigation devices, and the like. It would be understood by a person in the art that the configuration according to the embodiments of the present invention can be also applicable to the fixed types of terminals such as digital TVs, desk top computers, or the like, except for any elements especially configured for a mobile purpose.

FIG. 1 is a block diagram of a mobile terminal according to an embodiment of the present invention.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, and the like. FIG. 1 shows the mobile terminal as having various components, but it should be understood that implementing all of the illustrated components is not a requirement. Greater or fewer components may alternatively be implemented.

The elements of the mobile terminal will be described in detail as follows.

The wireless communication unit 110 typically includes one or more components allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel. The broadcast associated information may refer to information associated with a broadcast channel, a broadcast program or a broadcast service provider. The broadcast associated information may also be provided via a mobile communication network and, in this case, the broadcast associated information may be received by the mobile communication module 112. Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, and the like), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System).

With reference to FIG. 1, the A/V input unit 120 is configured to receive an audio or image signal. The A/V input unit 120 may include a camera 121 (or other image capture device) and a microphone 122 (or other sound pick-up device). The camera 121 processes image data of still pictures or video obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate input data from commands entered by a user to control various operations of the mobile terminal. The user input unit 130 may include a keypad, a dome switch, a touch pad (e.g., a touch sensitive member that detects changes in resistance, pressure, capacitance, and the like, due to being contacted) a jog wheel, a jog switch, and the like.

The sensing unit 140 (or other detection means) detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, and the like, and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device. The sensing unit 140 may include a proximity sensor 141.

The output unit 150 is configured to provide outputs in a visual, audible, and/or tactile manner (e.g., audio signal, image signal, alarm signal, vibration signal, etc.). The output unit 150 may include the display unit 151, an audio output module 152, an alarm unit 153, a haptic module 154, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, and the like.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, an e-ink display, or the like.

Some of them may be configured to be transparent or light-transmissive to allow viewing of the exterior, which may be called transparent displays. A typical transparent display may be, for example, a TOLED (Transparent Organic Light Emitting Diode) display, or the like. Through such configuration, the user can view an object positioned at the rear side of the terminal body through the region occupied by the display unit 151 of the terminal body.

The mobile terminal 100 may include two or more display units (or other display means) according to its particular desired embodiment. For example, a plurality of display units may be separately or integrally disposed on one surface of the mobile terminal, or may be separately disposed on mutually different surfaces.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

With reference to FIG. 1, a proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photo sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

The audio output module 152 may convert and output as sound audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function performed by the mobile terminal 100 (e.g., a call signal reception sound, a message reception sound, etc.). The audio output module 152 may include a speaker, a buzzer, or other sound generating device.

The alarm unit 153 (or other type of user notification means) may provide outputs to inform about the occurrence of an event of the mobile terminal 100. Typical events may include call reception, message reception, key signal inputs, a touch input etc. In addition to audio or video outputs, the alarm unit 153 may provide outputs in a different manner to inform about the occurrence of an event. For example, the alarm unit 153 may provide an output in the form of vibrations (or other tactile or sensible outputs). When a call, a message, or some other incoming communication is received, the alarm unit 153 may provide tactile outputs (i.e., vibrations) to inform the user thereof. By providing such tactile outputs, the user can recognize the occurrence of various events even if his mobile phone is in the user's pocket. Outputs informing about the occurrence of an event may be also provided via the display unit 151 or the audio output module 152. The display unit 151 and the audio output module 152 may be classified as a part of the alarm unit 153.

The haptic module 154 generates various tactile effects the user may feel. A typical example of the tactile effects generated by the haptic module 154 is vibration. The strength and pattern of the haptic module 154 can be controlled. For example, different vibrations may be combined to be outputted or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, and the like, an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM), a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

Method for Processing User Input with Respect to Mobile Terminal

The user input units 130 is manipulated to receive a command for controlling the operation of the mobile terminal 100 and may include a plurality of manipulation units 131 and 132. The manipulation units 131 and 132 may be generally referred to as a manipulating portion, and various methods and techniques can be employed for the manipulation portion so long as they can be operated by the user in a tactile manner.

The user input unit 130 is manipulated to receive a command for controlling the operation of the mobile terminal 100. The user input unit 130 may include a plurality of manipulation units. The manipulation units may be generally called a manipulating portion, and they can employ any method so long as they can be manipulated in a tactile manner by the user.

The display unit 151 can display various types of visual information. These types of information may be displayed in the form of characters, numerals, symbols, graphic or icons.

In order to input such information, at least one of the characters, numerals, symbols, graphic and icons may be displayed in predetermined arrangement in the form of a keypad. Also, the keypad can be referred to as a ‘soft key’.

The display unit 151 may be operated as an entire area or may be divided into a plurality of regions so as to be operated. In the latter case, the plurality of regions may be configured to be operated in association with each other.

For example, an output window and an input window may be displayed at an upper portion and a lower portion of the display unit 151. The output window and the input window are regions allocated to output or input information, respectively. Soft keys marked by numbers for inputting a phone number or the like may be outputted to the input window. When a soft key is touched, a number or the like corresponding to the touched soft key may be displayed on the output window. When the manipulation unit is manipulated, a call connection to the phone number displayed on the output window may be attempted or text displayed on the output window may be inputted to an application.

The display unit 151 or a touch pad may be configured to receive a touch through scrolling. The user can move an entity displayed on the display unit 151, for example, a cursor or a pointer positioned on an icon or the like, by scrolling the touch pad. In addition, when the user moves his finger on the display unit 151 or on the touch pad, a path along which the user's finger moves may be visually displayed on the display unit 151. This can be useful in editing an image displayed on the display unit 151.

A certain function of the terminal may be executed when the display unit 151 (touch screen) and the touch pad are touched together within a certain time range. For example, the display unit 151 and the touch pad may be touched together when the user clamps the terminal body by using his thumb and index fingers. The certain function may be activation or deactivation of the display unit 151 or the touch pad.

Exemplary embodiments related to a control method that can be implemented in the terminal configured as described above will now be described with reference to the accompanying drawings. The exemplary embodiments to be described may be solely used or may be combined to be used. Also, the exemplary embodiments to be described may be combined with the foregoing user interface (UI) so as to be used.

First, concepts or terms to be referred in describing exemplary embodiments in the present disclosure will now be explained.

Augmented Reality

Augmented reality (AR) refers to a direct or indirect live view in which components of a physical real world environment are augmented to appear by a virtual image generated by a computer. The AR fortifies a current recognition with respect to substance. In case of AR, augmentation is made according to a real time and semantic context with components in the real world environment, which is like the scores displayed along with a sports scene in a TV receiver. With the aid of a developed AR technique such as a computer vision and an addition of an object recognition, information regarding a real world around users is useful in an interactively digital manner. The real world environment and artificial information regarding an object in the environment may be stored and retrieved as an information layer added to a real world view.

AR Information

As described above with respect to the AR, AR information refers to guide information regarding an object existing in a real world, which can be obtained in a location-based scheme (GPS-based scheme), a marker recognition-based scheme, or the like. The objects, for which AR information can be displayed, may include every object whose guide information can be provided, such as articles, goods, buildings, a route map, public transportation, and the like. A mobile terminal may obtain AR information from a single AR information server or a plurality of AR information servers.

In detail, in the case of the location-based scheme, the mobile terminal may transmit GPS information and geomagnetic sensor information (direction, tilt information, etc.) to a server, obtain AR information regarding an object viewed by the mobile terminal (e.g., an object whose image is being captured by a camera of the mobile terminal) from the server, and display the obtained AR information on an actual image in an overlaid manner to thus provide guide information regarding the object.

Meanwhile, in the case of the marker recognition-based scheme, the mobile terminal may locate a marker appearing on an image, and recognize the size of the marker and the distance between the marker and the mobile terminal to determine a three-dimensional (3D) location of a marker-indicated object and/or distance. The mobile terminal may obtain AR information directly from the corresponding AR marker, or obtain AR information connected with the corresponding AR marker from the server and display the obtained AR information on an image or the marker position.

For example, the AR marker may be included in the form of an image, a two-dimensional (2D) code, or the like, in the Arm information, or may include various types of data such as a character, a number, a symbol, a control code, and the like. In this case, the mobile terminal may decode the image, the 2D code, or the like, of the AR marker with the AR information encoded therein to obtain the AR information. A specific scheme for configuring the AR marker with the 2D code can be understood in a similar manner to a known 2D code (e.g., QR code, PDF417, DataMatrix, MaxiCode, etc.), so a detailed description thereof will be omitted.

Alternatively, the AR marker may include information used to obtain or access AR information or provide the same. For example, the information may be a specific number given as a combination of numbers or characteristics which is different for each AR information, URL information allowing for accessing AR information, identification information (a serial number of an AR marker, or the like) identifying different AR markers, and the like. In this case, the mobile terminal may decode the image, the 2D code, or the like, of the information-encoded AR marker to obtain the information. The mobile terminal may obtain, upon inquiry to the server, AR information corresponding to said (the above-mentioned) information

AR Information Display Method and Mobile Terminal Using the Same

According to an AR information display method according to an exemplary embodiment of the present invention, AR information to be displayed or received is filtered according to a setting (filtering information) stored in the mobile terminal, whereby only AR information fitting the age of the user (subscriber) of the mobile terminal or blocking unsound or harmful AR information from being displayed.

Also, according to an AR information display method according to an exemplary embodiment of the present invention, the user (or a subscriber) himself of the mobile terminal or a manager (or a guardian) who is at a position of protecting the user of the mobile terminal can filter (permit or block) AR information (or AR data) to be displayed or received by the mobile terminal in various manners, and can receive information regarding the filtering results, whereby only AR information desired by the user of the mobile terminal or only AR information suitable for the user of the mobile terminal can be provided.

In detail, the mobile terminal 100 according to an exemplary embodiment of the present invention may filter AR information based on information (e.g., kids-lock information) regarding an age of the terminal user (subscriber) stored in a subscriber identity module (SIM), a universal subscriber identity module (USIM), and the like.

Also, the mobile terminal 100 according to an exemplary embodiment of the present invention may filter AR information based on content of a text message received from the manager (or guardian) or content directly input by the manager (or guardian) or the terminal user (or subscriber), or based on the location of the terminal.

Also, the mobile terminal 100 according to an exemplary embodiment of the present invention may activate or deactivate an AR information filtering function according to a reception message including an authentication code of the manager (or guardian). Namely, the controller 180 may be set the filtering information in order to block all the items of the AR information from being displayed or release displaying of all the items of the AR information when a message including a predetermined authentication code is received.

Also, the mobile terminal 100 according to an exemplary embodiment of the present invention may process AR information, as a blocking target, to be graphic-processed such as mosaic-processed, or stopping displaying of a preview screen image regarding scanning of a destructive area having a large number of times of blocking, display information regarding the number of times of blocking, or when the AR information has been blocked by more than a certain number of times of blocking, the mobile terminal 100 may inform the manager (guardian) accordingly.

Hereinafter, the operation or the function of the mobile terminal 100 according to a scheme of setting filtering of AR information and a scheme of displaying filtering results according to an exemplary embodiment of the present invention will now be described.

Filtering Setting Scheme

The camera 121 captures an image of a subject (or object) of a real world. The display unit 151 may display a preview screen image of the captured image.

The wireless communication unit 110 transmits information for designating the subject whose image has been captured (or the image-captured subject) to the server, and receives AR information related to the captured image of the subject from the server. Here, the server may be an AR information server. The information designating the image-captured subject may include location information and direction information of the mobile terminal which captures the image of the subject, or may include identification information of a marker indicated in or attached to the image-captured subject.

The controller 180 controls the display unit 151 to display the received AR information based on the filtering information (filtering setting) stored in the memory 160. In particular, the filtering information (filtering setting) may be stored in an SIM card or a USIM card. The filtering information may be transmitted in the form of a sort of configuration file to a remote area (e.g., a different mobile terminal) so as to e used to configure the same filtering environment in the remote area.

In this case, the filtering information (filtering setting) may include subscriber age information. The controller 180 may provide control to display the AR information only when the subscriber age is higher than a permitted age of the AR information.

To this end, age class information for designating an age to which the corresponding AR information can be provided may be added in the form of meta data to each AR information. The meta data may be stored in a certain space within a data format configuring the AR information, or may be stored in a server, or the like, separately from the AR information, and associated with the AR information.

Upon receiving the AR information from the server, the controller 180 may read the meta data included in the AR information to first check an age class of the AR information to be received. Or, before receiving the AR information, the controller 180 may receive the meta data from the server and first check the age class of the AR information to be received.

Meanwhile, the filtering information (filtering setting) may include the entirety or a portion of content of the reception information. The controller 180 may provide control to display only the AR information including information which is the same as or similar to the content of the reception message included in the filtering information. For example, the controller 180 may provide control to display only AR information including information or a phrase which is the same as or similar to at least one character, number, symbol, figure (or diagram), or a combination thereof included in the content of the reception message.

Or, the controller 180 may provide control to prevent AR information including information which is the same as or similar to the content of the reception message included in the filtering information, from being displayed. Namely, the controller 180 may provide control to prevent the AR information including information or a phrase which is the same as or similar to at least one character, number, symbol, figure (or diagram), or a combination thereof included in the content of the reception message, from being displayed.

For example, when a manager (or guardian) inputs information or a phrase desired to be blocked from being displayed to text of a message and transmitted, the mobile terminal 100, upon receiving the text message, may block AR information including the information or the phrase described in the text of the reception message from being displayed later.

Meanwhile, the filtering information (filtering setting) may include at least one character, number, symbol, figure (or diagram), or a combination thereof designated by a user input signal. The controller 180 may provide control to display only AR information including information or a phrase which is the same as or similar to the at least one designated character, or the like. Or, the controller 180 may provide control to block AR information including information or a phrase which is the same as or similar to the at least one designated character, or the like, from being displayed.

For example, when the user (or subscriber) inputs a word or a phone number desired to be blocked from being displayed, through a filtering setting screen image, the mobile terminal 100 may block AR information including the inputted word or phone number or including a similar word or phone number from being displayed.

Meanwhile, the filtering information (filtering setting) may include location information. In particular, the location information may be GPS information. The controller 180 may provide control to display AR information only when the mobile terminal 100 is adjacent to a location designated by location information included in filtering information with reference to location information provided by the location information module 115. Similarly, the controller 180 may provide control to prevent AR information from being displayed when location information included in the AR information is adjacent to a designated position.

For example, when the manager (guardian) directly inputs GPS information/address, a radius distance, or the like on a filtering setting screen image, the mobile terminal 100 may not display AR information within a determined radius from the location designated by the GPS information/address.

According to the above description, the mobile terminal 100 according to an exemplary embodiment of the present invention receives AR information, and then determines whether to display the received AR information or whether to prevent the received AR information from being blocked according to the filtering information. In this manner, the AR information can be prevented from being displayed or receiving of AR information corresponding to a target (or subject) to be blocked may be blocked. The mobile terminal 100 according to a different exemplary embodiment of the present invention may selectively receive only AR information to be displayed according to filtering information.

In detail, the wireless communication unit 110 transmits information for designating a subject whose image is to be captured to the server, and receives AR information related to the image-captured subject from the server. The controller 180 controls the display unit 15 to display the received AR information.

In particular, the wireless communication unit 110 may transmit the filtering information stored in the memory 160 to the server, and receive only permitted AR information according to the filtering information from the AR information. Namely, the server may determine whether to transmit AR information regarding the image-captured subject to the mobile terminal 100 according to the filtering information provided by the mobile terminal 100.

For example, based on subscriber age information included in the filtering information, the server may transmit the AR information to the mobile terminal 100 only when the subscriber age is higher than a permitted age according to the age class of the AR information.

The wireless communication unit 110 may transmit information for designating the image-captured subject to the server and receive a summary of the AR information regarding the image-captured subject from the server. Here, the summary of the AR information may refer to a keyword, core information, meta data, or the like, describing the AR information.

When the controller 180 determines to receive the AR information based on the filtering information and the received summary, the wireless communication unit 110 may receive the AR information or may not receive it according to the determination of the controller 180.

Or, the controller 180 may search for content of AR information received by the wireless communication unit 110 in real time, and when content or a phrase designated to be blocked is included in the filtering information, the controller 180 may control the wireless communication unit 110 to stop receiving the remaining portion of the AR information.

The mobile terminal 100 according to a different exemplary embodiment of the present invention can be understood similarly as described above with reference to the mobile terminal 100 according to an exemplary embodiment of the present invention, so a detailed description thereof will be omitted.

A method for displaying filtering results of the AR information will now be described.

Displaying of Filtering Results

As described above, the controller 180 determines whether to display AR information or whether to block AR information from being displayed based on filtering information. When the AR information is determined to be blocked from being displayed, the controller 180 may control the display unit 151 to process the AR information such that it is mosaic, blurred, or colored, so as to be displayed. Also, the controller 180 may control an object to be blocked from being displayed on a preview screen image such that it is mosaic or graphically processed so as to be displayed.

Or, as described above, when the display unit 151 displays a preview screen image of a captured image, the controller 180 may determine whether to block the AR information from being displayed on the preview screen image based on the filtering information.

When the number of items of AR information blocked from being displayed is smaller than a predetermined number, the controller f180 may control the display unit 141 to display AR information not blocked from being displayed and the preview screen image. When the number of items of AR information blocked from being displayed is equal to or greater than the predetermined number, the controller 180 may control the display unit 151 to stop displaying of the AR information and the preview screen image.

Or, when the number of items of the AR information blocked from being displayed is equal to or greater than the predetermined number, the controller 180 may control the display unit 151 to display a phrase (e.g., a phrase informing that an area is harmful to minors) indicating that the AR information is blocked from being displayed or a numerical value (e.g., a numerical value corresponding to the a harmful area index or the number of items of harmful AR information) corresponding to the number of the items of the AR information blocked from being displayed.

Meanwhile, as described above, the controller 180 may permit the AR information to be displayed or block the AR information from being displayed based on the filtering information. When the number of items of the AR information blocked from being displayed is larger than a predetermined number, the controller 180 may control the wireless communication unit 110 to transmit a notification message to a remote area (e.g., the mobile terminal of the terminal manager (or guardian).

FIG. 2 illustrates an example of interrupting displaying of augmented reality information by a mobile terminal according to an exemplary embodiment of the present invention. In FIG. 2, AR information filled with dots denotes AR information which has been received but not actually displayed by the mobile terminal 100.

As shown in FIG. 2, the mobile terminal receives AR information regarding a subject whose image is to be captured (210). Hereinafter, it is assumed that AR information regarding “New Palace Club” and “Bar Coco” is information not appropriate for minors, which are targets to be blocked from being displayed.

The mobile terminal 100 may not display AR information regarding “New Palace Club” and “Bar Coco” on a preview screen image of the captured image (2200 or may process “New Palace Club” and “Bar Coco” to be mosaic so as to be displayed (230). Or, in case in which filtering setting has been set to completely block AR information and a preview screen image from being displayed when two or more targets not appropriate for minors are displayed on the preview screen image, the mobile terminal 100 may display a phrase (“Inappropriate for the minor!”) and a harmfulness grade indicating the number of targets not appropriate for minors (240), rather than displaying the preview screen image of the captured image and the AR information.

FIGS. 3 to 5 are flow charts illustrating the processes of a method for displaying AR information according to an exemplary embodiment of the present invention.

With reference to FIG. 3, the mobile terminal 100 captures an image of a subject (step S310). The mobile terminal 100 may display a preview screen image of the captured image (S320).

The mobile terminal transmits information for designating the image-captured subject to the server (step S330). Here, the information for designating the image-captured subject may include location information and direction information of the mobile terminal which captures the image of the subject or identification information of a marker indicated in or attached to the captured image of the subject.

The mobile terminal 100 receives AR information related to the captured image of the subject from the server (step S350).

The mobile terminal 100 displays the received AR information based on the filtering information stored in the mobile terminal (step S370). The filtering information may be stored in a subscriber identity module (SIM) card or in a universal subscriber identity module (USIM) card of the mobile terminal.

In this case, the filtering information may include subscriber age information, and only when a subscriber age is higher than a permitted age according to the age class of the AR information, the mobile terminal 100 may display the AR information.

Or, the filtering information may include at least a portion of content of a reception message, and the mobile terminal 100 may display the AR information including information which is the same as or similar to the content of the reception message or may prevent the received AR information including information which is the same as or similar to the content of the reception message from being displayed.

Or, the filtering information may include at least one character, number, symbol, or figure (or diagram) designated by a user input signal, and the mobile terminal 100 may display the AR information including information which is the same as or similar to the at least one character, number, symbol, or figure (or diagram), or the like, or block the AR information including information which is the same as or similar to the at least one character, number, symbol, or figure (or diagram) from being displayed.

Or, the filtering information may include location information, and the mobile terminal 100 may display the AR information only when the location information is adjacent to a location designated by the location information, or may prevent the AR information from being displayed when the location information is adjacent to the location designated by the location information.

With reference to FIG. 4, the mobile terminal 100 may perform a step (S371) of determining whether to block the AR information from being displayed based on the filtering information and a step (S372) of displaying the AR information by processing it to be mosaic, blurred, or colored when it is determined to block the AR information from being displayed.

Also, with reference to FIG. 5, the mobile terminal 100 may perform a step (S371) of determining whether to block the AR information from being displayed based on the filtering information, a step (S374) of displaying AR information not blocked from being displayed and displaying the preview screen image when the number of items of the AR information blocked from being displayed is smaller than a predetermined number (step S373), and a step (S375) of stopping displaying of the AR information and the preview screen image when the number of items of the AR information blocked from being displayed is equal to or larger than a predetermined number (step S373).

In this case, when the number of items of the AR information blocked from being displayed is equal to or larger than the predetermined number, the mobile terminal 100 may perform a step (S376) of displaying a phrase indicating that displaying of the AR information is blocked or a numerical value corresponding to the number of the items of the AR information blocked from being displayed.

Meanwhile, the mobile terminal 100 may set the filtering information such that all the items of the AR information are blocked from being displayed or released from a blocked state when a message including a predetermined authentication code is received. Or, when the number of items of AR information blocked from being displayed is equal to or greater than the predetermined number, the mobile terminal 100 may transmit a notification message to a remote area. Or, the mobile terminal 100 may transmit the filtering information to the remote area.

FIGS. 6 to 8 are flow charts illustrating the processes of a method for displaying AR information according to another exemplary embodiment of the present invention.

As shown in FIG. 6, the mobile terminal captures an image of a subject (step S610). The mobile terminal 100 transmits information for designating the image-captured subject to the server (S630). The mobile terminal 100 receives AR information related to the captured image of the subject from the server based on the filtering information stored in the mobile terminal (step S650). The mobile terminal displays the received AR information (step S670).

In particular, the filtering information may include subscriber age information, and only when the subscriber age is higher than a permitted age according to an age class of the AR information, the mobile terminal 100 may receive the AR information.

Or, with reference to FIG. 7, the mobile terminal 100 may perform a step (S651) of transmitting the filtering information to the server and a step (S652) of receiving only the AR information permitted according to the filtering information from the server.

Or, with reference to FIG. 8, the mobile terminal 100 may perform a step (S653) of receiving a summary of the AR information from the server, a step (S654) of determining whether to receive the AR information based on the filtering information and the received summary, and a step (S655) of receiving or not receiving the AR information from the server according to the determination of whether to receive the AR information.

The methods according to the exemplary embodiments of the present invention can be understood similarly as described above with reference to the mobile terminal 100 according to the exemplary embodiments of the present invention with reference to FIGS. 1 and 2, so a detailed description thereof will be omitted.

In the embodiments of the present invention, the above-described method can be implemented as codes that can be read by a computer in a program-recorded medium. The computer-readable medium includes various types of recording devices in which data read by a computer system is stored. The computer-readable medium may include a ROM, a RAM, a CD-ROM, a magnetic tape, a floppy disk, an optical data storage device, and the like. The computer-readable medium also includes implementations in the form of carrier waves or signals (e.g., transmission via the Internet).

The mobile terminal according to the embodiments of the present disclosure is not limited in its application of the configurations and methods, but the entirety or a portion of the embodiments can be selectively combined to be configured into various modifications.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

Therefore, in order to address the above matters, the various features described herein have been conceived.

Another object of the present invention is to provide a method for displaying augmented reality information capable of providing filtered augmented reality (AR) information to a user according to a setting of a terminal user (or subscriber) or a terminal manager (guardian).

To achieve these and other advantages and in accordance with the purpose of the present invention, as embodied and broadly described herein, the present invention provides in one aspect a method for displaying AR information of a mobile terminal, including: capturing an image of a subject; transmitting information designating the captured image of the subject to a server; receiving augmented reality (AR) information relevant to the captured image of the subject; and displaying the received AR information based on filtering information stored in the mobile terminal.

To achieve these and other advantages and in accordance with the purpose of the present invention, as embodied and broadly described herein, the present invention provides in another aspect a method for displaying AR information of a mobile terminal, including: capturing an image of a subject; transmitting information designating the captured image of the subject to a server; receiving augmented reality (AR) information relevant to the captured image of the subject from the server based on filtering information stored in the mobile terminal; and displaying the received AR information.

To achieve these and other advantages and in accordance with the purpose of the present invention, as embodied and broadly described herein, the present invention provides in another aspect a mobile terminal including: a display unit; a camera configured to capture an image of a subject; a wireless communication unit configured to transmit information for designating the captured image of the subject to a server, and receive augmented reality (AR) information relevant to the captured image of the subject from the server; and a controller configured to control the display unit to display the received AR information based on filtering information stored in a memory.

To achieve these and other advantages and in accordance with the purpose of the present invention, as embodied and broadly described herein, the present invention provides in another aspect a mobile terminal including: a display unit; a camera configured to capture an image of a subject; a wireless communication unit configured to transmit information for designating the captured image of the subject to a server, and receive augmented reality (AR) information relevant to the captured image of the subject from the server based on filtering information stored in the mobile terminal; and a controller configured to control the display unit to display the received AR information.

According to exemplary embodiments of the present invention, in the method for displaying AR information and a mobile terminal using the same, because AR information to be displayed or received is filtered according to a setting (i.e., filtering information) stored in the mobile terminal, only AR information appropriate for the age of a user (or subscriber) of the mobile terminal can be provided and unwholesome or unhealthy AR information can be blocked.

Also, because the user (or the subscriber) of the terminal or a manager (or a guardian) at the position to protect the user of the mobile terminal can filter (permit or block) AR information (or AR data) to be displayed or received by the mobile terminal in various manners and can be provided with information regarding the filtering results. Thus, AR information desired by the terminal user or only AR information suitable for the terminal user can be provided.

The foregoing and other objects, features, aspects and advantages of the present invention will become more apparent from the following detailed description of the present invention when taken in conjunction with the accompanying drawings.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for displaying augmented reality (AR) information on a mobile terminal, the method comprising:
receiving and storing filtering information at the mobile terminal;
capturing an image of a subject;
transmitting information regarding the captured image of the subject to a server;
receiving augmented reality (AR) information related to the transmitted information; and
displaying the received AR information on a screen based on the stored filtering information.

2. The method of claim 1, wherein the filtering information includes subscriber age information, and wherein displaying the received AR information includes displaying the AR information on the screen only when a subscriber's age is higher than a permissible age based on an age class of the AR information.

3. The method of claim 1, wherein receiving and storing the filtering information includes receiving a reception message, wherein the filtering information includes at least a portion of content of the reception message, and wherein displaying the received AR information includes displaying the received AR information that is the same as or is similar to the content of the reception message, or preventing the display of the received AR information that is the same as or is similar to the content of the reception message.

4. The method of claim 1, wherein receiving and storing the filtering information includes receiving a user input of at least one character, number, symbol, or figure, and wherein displaying the received AR information includes displaying the received AR information that is the same as or is similar to the at least one character, number, symbol or figure, or preventing the displaying of the received AR information that is the same as or is similar to the at least one character, number, symbol, or figure.

5. The method of claim 1, wherein the filtering information includes location information, and wherein displaying the received AR information includes displaying the AR information only when the mobile terminal is adjacent to a location corresponding to the location information of the mobile terminal, or preventing the AR information from being displayed when the mobile terminal is adjacent to a location corresponding to the location information of the mobile terminal.

6. The method of claim 1, wherein displaying the received AR information comprises:
determining to alter AR information from being displayed based on the filtering information; and
when it is determined to alter the AR information from being displayed, the AR information is processed to be mosaic, blurred, or colored when displayed on the screen.

7. The method of claim 1, further comprising:
displaying a preview screen image of the captured image,
wherein displaying the received AR information includes:
determining a number of items of the received AR information to block from being displayed based on the filtering information;
displaying the preview screen image and the AR information that is not blocked from being displayed when the determined number of items of the received AR information to block from being displayed is less than a predetermined number; and
stopping displaying of the preview screen image and the AR information when the determined number of items of the received AR information to block from being displayed is greater than or equal to the predetermined number.

8. The method of claim 7, wherein displaying the received AR information includes displaying a phrase indicating that the AR information is blocked from being displayed or displaying a numerical value corresponding to the determined number of the items when the determined number of items of the received AR information to block from being displayed is equal to or greater than the predetermined number.

9. The method of claim 1, further comprising:
setting the filtering information such that all items of the AR information are blocked from being displayed and such that the blocked items are released from a blocked state when a message that includes a predetermined authentication code is received at the mobile terminal.

10. The method of claim 1, further comprising:
transmitting a notification message to a remote area when a number of items of the received AR information being blocked from being displayed is equal to or greater than a predetermined number.

11. The method of claim 10, further comprising:
transmitting the filtering information to the remote area.

12. The method of claim 1, wherein the transmitted information includes location information of the mobile terminal, direction information of the mobile terminal, or identification information of a marker corresponding to the captured image of the subject.

13. The method of claim 1, wherein storing the filtering information includes storing the filtering information in a subscriber identity module (SIM) card or in a universal subscriber identity module (USIM) card.

14. A mobile terminal comprising:
a display;
a camera to capture an image of a subject;
a memory to store filtering information;
a wireless communication unit to transmit information regarding the captured image of the subject to a server, and to receive augmented reality (AR) information related to the transmitted information; and
a controller to perform a filtering operation of the received AR information based on the stored filtering information, and to control the display to display the received AR information after performing the filtering operation.

15. The mobile terminal of claim 14, wherein the filtering information includes subscriber age information, and the controller performs the filtering operation to control the display to display the AR information only when the subscriber age is higher than the age permitted based on an age class of the received AR information.

16. The mobile terminal of claim 14, wherein the wireless communication unit receives a reception message, wherein the filtering information includes at least a portion of content of the reception message, and the controller performs the filtering operation to control the display to display the received AR information that is the same as or is similar to the content of the reception message, or the controller performs the filtering operation to prevent the displaying of the received AR information that is the same as or is similar to the content of the reception message.

17. The mobile terminal of claim 14, further comprising a user input to provide a user input signal of at least one character, number, symbol, or figure, and the controller performs the filtering operation to control the display to display the received AR information that is the same as or is similar to the at least one character, number, symbol or figure, or the controller performs the filtering operation to control the display to prevent the displaying of the AR information that is the same as or is similar to the at least one character, number, symbol or figure.

18. The mobile terminal of claim 14, wherein the filtering information includes location information, and the controller performs the filtering operation to control the display to display the received AR information only when the mobile terminal is adjacent to a location corresponding to the location information of the mobile terminal, or the controller performs the filtering operation to control the display to prevent the displaying of the received AR information when the mobile terminal is adjacent to a location corresponding to the location information of the mobile terminal.

19. The mobile terminal of claim 14, wherein the controller determines to alter AR information from being displayed based on the filtering information, and when the controller determines to alter the AR information from being displayed, the controller provides control to process the AR information to be mosaic, blurred, or colored when displayed on the display.

20. The mobile terminal of claim 14, wherein the display displays a preview screen image of the captured image, and the controller determines a number of items of the received AR information to block from being displayed based on the filtering information, and the controller provides control to display the preview screen image and the AR information that is not blocked from being displayed when the determined number of items of the received AR information to block from being displayed is smaller than a predetermined number, and the controller provides control to stop displaying of the preview screen image and the AR information when the determined number of items of the received AR information to block from being displayed is equal to or greater than the predetermined number.

21. The mobile terminal of claim 20, wherein the controller controls the display to display a phrase indicating that the AR information is blocked from being displayed or to display a numerical value corresponding to the determined number of the items when the determined number of items of the received AR information to block from being displayed is equal to or greater than the predetermined number.

22. The mobile terminal of claim 14, wherein the controller sets the filtering information such that all items of the AR information are blocked from being displayed and such that the blocked items are released from a blocked state when a message including a predetermined authentication code is received at the mobile terminal.

23. The mobile terminal of claim 14, wherein the controller provides control to transmit a notification message to a remote area when a number of items of AR information blocked from being displayed is equal to or greater than a predetermined number.

24. The mobile terminal of claim 23, wherein the wireless communication unit transmits the filtering information to the remote area.

25. The mobile terminal of claim 14, wherein the transmitted information includes location information of the mobile terminal, direction information of the mobile terminal, or identification information of a marker corresponding to the captured image of the subject.

26. The mobile terminal of claim 14, wherein the memory is one of a subscriber identity module (SIM) card or a universal subscriber identity module (USIM) card.

27. A method for displaying on a mobile terminal, the method comprising:
receiving an image at the mobile terminal;
transmitting information regarding the received image;
receiving augmented reality (AR) information related to the transmitted information; and
performing a filtering operation, based on stored filtering information, in order to either prepare a display a portion of the received AR information on a screen or to block a display of a portion of the received AR information.

28. The method of claim 27, wherein the preparing of the display of the portion of the AR information includes processing the AR information to be mosaic, blurred or colored when displayed.

29. The method of claim 27, further comprising determining a number of items of the AR information to block from being displayed.

30. The method of claim 29, further comprising displaying a screen image and a portion of the AR information on a screen when the determined number of items to block is less than a predetermined number.

31. The method of claim 29, wherein to block the display of the portion includes stopping the displaying of a screen image when the determined number of items to block is equal to or is greater than a predetermined number.
